(19) United States
(12) Patent Application Publication
(10) Pub. No.: US 2008/0155801 A1
(43) Pub. Date: Jul. 3, 2008

(54) Electret condenser microphone and manufacturing method thereof

(76) Inventor: Hirofumi Imanaka, Niigata (JP)

Correspondence Address: MCDERMOTT WILL & EMERY LLP, 600 13TH STREET, NW, WASHINGTON, DC, 20005-3096, US

(21) Appl. No.: 11/976,236

(22) Filed: Oct. 23, 2007

(30) Foreign Application Priority Data
Dec. 28, 2006 (JP) 2006-356039
Aug. 30, 2007 (JP) 2007-223874

(51) Int. Cl. H04R 19/01

(52) U.S. Cl. 29/25.41

(57) ABSTRACT

An electret condenser microphone includes a first electrode provided with an electret and a second electrode opposed to the first electrode with an air gap interposed. In manufacture of the electret condenser microphone, after degasification is performed on the inside of the air gap, water repellent finishing is performed on at least the inside of the air gap.

### BACKGROUND OF THE INVENTION

1. Field of the Invention

The present invention relates to acoustic detection machinery manufacturing methods, and more particularly relates to an electret condenser microphone formed by using MEMS (Micro Electro Mechanical System) technology and a manufacturing method thereof.

2. Background Art

Electret condenser microphones are subminiature microphones including a parallel plate condenser, wherein the operation principal thereof is such that when one of the electrodes of the condenser vibrates in response to variation in sound pressure, the capacitance of the condenser varies to cause the variation to be converted to a voltage signal in the end.

The electret condenser microphones are grouped into two: a joint type manufactured by joining a plurality of components; and an integrally formed type in which a whole microphone is manufactured integrally by applying semiconductor technology, that is, MEMS technology.

The joint type has long been the mainstream because of is simple manufacturing method. While, the employed joining technique limits improvement on thermal resistance, reduction in size and cost, improvement on processing reliability at the joint parts, and the like. In view of this, integrally formed electret condenser microphones have been reduced to practice in which a whole microphone is manufactured integrally by applying the semiconductor technology.

One example of conventional integrally formed electret condenser microphones, which is disclosed in Patent Document 1, will be described below in detail with reference to FIG. 8.

FIG. 8 is a sectional view of the integrally formed electret condenser microphone disclosed in Patent Document 1.

As shown in FIG. 8, a silicon oxide film 202 is formed on a semiconductor substrate 201, and a membrane region 213 is formed by partially removing the semiconductor substrate 201 and the silicon oxide film 202 with respective predetermined parts (peripheral parts) thereof left. The membrane region 213 is a region where the semiconductor substrate 201 is removed partially for allowing a vibrating film 212, which will be described later, to vibrate upon receipt of pressure from outside. A silicon nitride film 203 is formed on the silicon oxide film 202 so as to extend across the membrane region 213. One conductive film serving as a lower electrode 204 and an extraction wiring 215 is formed on the silicon nitride film 203. A silicon oxide film 205 and a silicon nitride film 206 are sequentially formed on the silicon nitride film 203, the lower electrode 204, and the extraction wiring 215. Leak holes 207 are formed through the silicon nitride film 203, the lower electrode 204, the silicon oxide film 205, and the silicon nitride film 206, and respective parts of the lower electrode 204 and the silicon oxide film 205 which are located within the membrane region 213 are covered with the silicon nitride film 203 or the silicon nitride film 206.

A combination of respective parts of the silicon nitride film 203, the lower electrode 204, the silicon oxide film 205, and the silicon nitride film 206 which are located within the membrane region 213 forms the vibrating film 212. The silicon oxide film 205 is an electret film storing charges. A fixing film (an upper electrode) 210 formed of a conductive film covered with a silicon nitride film 214 is formed above the silicon nitride film 206. An air gap 209 is formed between the vibrating film 212 and the fixing film 210, and a silicon oxide film 208 is formed between the fixing film 210 and respective parts of the silicon nitride film 206 and the silicon oxide film 202 which are located outside the membrane region 213. The air gap 209 ranges over at least the membrane region 213. A plurality of acoustic holes 211 are formed through a part of the fixing film 210 (or the silicon nitride film 214 covering it) which is located above the air gap 209. An opening 216 is formed through the silicon nitride film 214, the fixing film 210, and the silicon oxide film 208 so as to expose a part of the extraction wiring 215, and an opening 217 is formed through the silicon nitride film 214 so as to expose a part of the fixing film 210.

FIG. 9A to FIG. 9F schematically show respective steps of a conventional method of manufacturing an electret condenser microphone having the same basic construction as that of the integrally formed electret condenser microphone disclosed in Patent Document 1. In FIG. 9A to FIG. 9F, the same reference numerals are assigned to the same components as those of the electret condenser microphone shown in FIG. 8 for omitting duplicated explanation and some of the components are not shown for the sake of simple explanation.

First, as shown in FIG. 9A, a silicon oxide film 202 is formed on each of the obverse face and the reverse face of a semiconductor substrate 201 made of silicon. Then, as shown in FIG. 9B, a silicon nitride film 203, a conductive film to serve as a lower electrode 204, a silicon oxide film 205, and a silicon nitride film 206 are formed sequentially on the silicon oxide film 202 on the obverse face of the semiconductor 201, and the lower electrode 204, leak holes 207, and a vibrating film 212 are formed by a combination of lithography and etching.

Next, as shown in FIG. 9C, a sacrifice layer oxide film 218 where an air gap 209 is to be formed in the end is grown.

Subsequently, as shown in FIG. 9D, a fixing film 210 formed of a conductive film covered with a silicon nitride film 214 (not shown) and having a concavo-convex structure is formed on the sacrifice layer oxide film 218 by a combination of film deposition, lithography, and etching, and then, acoustic holes 211 are formed through the fixing film 210. Then, as shown in FIG. 9E, through holes 219 are formed by a combination of lithography and etching so as to pass through the semiconductor substrate 201 from the reverse side of the semiconductor substrate 201 to the silicon oxide film 202 on the obverse face of the semiconductor substrate 201.

Thereafter, as shown in FIG. 9F, the sacrifice layer oxide film 218 is wet etched partially through the acoustic holes 211 to form an air gap 209 between the fixing film 210 and the vibrating film 212. At this wet etching, the silicon oxide film 202 on the obverse face of the semiconductor substrate 201 is also etched partially through the leak holes 207.

Thus, the integrally formed electret condenser microphone is completed in which the vibrating film 212 having the functions of the lower electrode and the electret and the fixing film 210 having the function of the upper electrode are opposed to each other with the air gape 209 interposed.

The electret condenser microphones have a construction in which the electret film is exposed to the outside air through the acoustic holes. Accordingly, in the case where they are used alternately between high-temperature and humid environment and low-temperature and dry environment, namely, in the case where they experience condensation environment, the inside of the air gap, of which openings (the acoustic holes and the leak holes) communicating with the outside air are small in area, is situated in a severe condition liable to cause condensation. Condensation causes the vibrating film and the fixing film to adhere to each other to invite leakage of the charges stored in the electret to the outside.

In order to solve the above problem, Patent Document 2 proposes a method for preventing the charges stored in the electret from leaking outside, in which a joint type electret condenser microphone is left in a HMDS (hexamethyldisilazane) atmosphere for rendering water-repellency to the inside of the air gap to prevent the vibrating film and the fixing film from adhesion to each other caused by condensation.

The joint type electret condenser microphone manufacturing method disclosed in Patent Document 2 will be described below with reference to the drawings. FIG. 10A to FIG. 10F show respective steps of the conventional electret condenser microphone manufacturing method disclosed in Patent Document 2.

First, as shown in FIG. 10A, a silicon oxide film 302 is formed on each of the obverse face and the reverse face of a semiconductor substrate 301. Then, as shown in FIG. 10B, the upper part of the semiconductor substrate 301 is selectively removed together with the silicon oxide film 302 on the obverse face of the substrate 301 by a combination of lithography and etching to form recesses serving as air gaps 309 (see FIG. 10F).

Next, as shown in FIG. 10C, the silicon oxide film 302 is formed again at respective parts of the obverse face of the semiconductor substrate 301 which are exposed to the recesses. Then, as shown in FIG. 10D, through holes 319 are formed by a combination of lithography and etching so as to pass through the semiconductor substrate 301 from the reverse side of the semiconductor substrate 301 to parts of the silicon oxide film 302 which are located within the recesses.

Subsequently, as shown in FIG. 10E, the electret condenser microphone in course of manufacture is left in a HMDS atmosphere to render water repellency to the silicon oxide film 302 (a part having water-repellency is denoted by reference numeral 322 (black circles) in the drawings).

Finally, as shown in FIG. 10F, a vibrating film 312 is joined to the obverse face of the semiconductor substrate 301 so as to cover the recesses. The vibrating film 312 has a film structure, for example, in which a conductive film is formed on an insulting film, such as a silicon oxide film. Thus, the joint type electret condenser microphone is manufactured in which: the semiconductor substrate 301 serves as a lower electrode; the recesses covered with the vibrating film 312 serve as the air gaps 309; and respective parts of the silicon oxide film 302 which are located within the air gaps 309 serve as electrets.

Patent Document 1: Japanese Patent Application Laid Open Publication No. 2006-074102

Patent Document 2: U.S. Pat. No. 4,910,840

### SUMMARY OF THE INVENTION

Water repellent finishing with respect to an electret condenser microphone with the use of a HMDS material as disclosed in Patent Document 2, however, achieves insufficient prevention of leakage of the charges stored in the electrets to the outside.

In view of the foregoing, the present invention has its object of definitely preventing leakage of the charges stored in an electret to outside in an electret condenser microphone.

To attain the above object, the inventor contemplated the following invention first as a method for preventing the charges from leaking outside from an electret even in condensation environment.

Namely, an electret condenser microphone manufacturing method in accordance with a first aspect of the present invention is a method for manufacturing an electret condenser microphone which includes a first electrode including an electret and a second electrode opposed to the first electrode with an air gap interposed, the method including the steps of: (a) performing degasification on the inside of the air gap; and (b) performing water repellent finishing on at least the inside of the air gap after the step (a).

In the electret condenser microphone manufacturing method in accordance with the first aspect of the present invention, degasification is performed before water repellent finishing with respect to the inside of the air gap. In other words, water repellent finishing is performed after moisture, alcohol, and the like remaining in the air gap are evaporated and removed by degasification. This achieves definite water repellent finishing inside the air gap, thereby rendering strong water repellency to the inner wall of the air gap and the like. Accordingly, even in sever environment liable to cause condensation, the charges stored in the electret are prevented from leakage to the outside caused by condensation, improving the reliability of the electret condenser microphone.

In the electret condenser microphone manufacturing method in accordance with the first aspect of the present invention, it is preferable to perform heating treatment in a HMDS atmosphere in the step (b).

This causes substitution of an OH group (strictly H of the OH group) by a Si(HC₃)₃ group in the air gap in which only the OH group remains by removal of moisture, alcohol, and the like by degasification, thereby rendering strong water repellency to the inner wall of the air gap and the like.

In the electret condenser microphone manufacturing method in accordance with the first aspect of the present invention, it is preferable to perform at least one of vacuuming and baking the step (a).

This definitely evaporates and removes moisture, alcohol, and the like remaining in the air gap.

In the electret condenser microphone manufacturing method in accordance with the first aspect of the present invention, degasification and water repellent finishing may be performed in the same chamber or different chambers.

Referring to a joint type electret condenser microphone, as disclosed in Patent Document 2, it is left in a HMDS environment for improving the water repellency of the vibrating film and the fixing film to prevent adhesion of the vibrating film and the fixing film to each other caused by condensation, thereby preventing the charges stored in the electret from leaking outside to some extent. On the other hand, in manufacture of an integrally formed electret condenser microphone, which recently receives attention, direct application of the water repellent finishing disclosed in Patent Document 2 thereto renders both the vibrating film and the fixing film water-repellent insufficiently, with a result that adhesion of the vibrating film and the fixing film to each other caused by condensation cannot be avoided. In other words, the integrally formed electret condenser microphone encounters difficulty in preventing the charges stored in the electret from leaking outside when compared with the joint type electret condenser microphones.

In view the foregoing, the inventor conducted the following examination for the purpose of preventing the charges stored in the electret from leaking outside in such a manner that adhesion of the vibrating film and the fixing film to each other caused by condensation is prevented by improving the water repellency of both the vibrating film and the fixing film in the integrally formed electret condenser microphone. Namely, in order to track a cause of significant difference in water repellency of the vibrating film and the fixing film rendered by water repellent finishing between the integrally formed electret condenser microphone and the joint type electret condenser microphone, the inventor examined and compared in detail the manufacturing method of the integrally formed electret condenser microphone disclosed in Patent Document 1 where the water repellent finishing disclosed in Patent Document 2 is applied and the electret condenser microphone manufacturing method disclosed in Patent Document 2 to acquire the following acknowledge.

FIG. 11A and FIG. 11B are illustrations for explaining states of water repellent finishing performed on the inner wall of the air gap in the manufacturing method of the integrally formed electret condenser microphone disclosed in Patent Document 1 where the water repellent finishing disclosed in Patent Document 2 is applied.

As shown in FIG. 9F, the manufacturing method of the integrally formed electret condenser microphone includes a step of forming the air gap 209 between the fixing film 210 and the vibrating film 212 by wet etching the sacrifice layer oxide film 218 partially. In this wet etching, as shown in FIG. 11A, alcohol molecules (for example, CH₃OH), water molecules (H₂O), and the like, which inhibit substitution by the Si(CH₃)₃ group, are present in each vicinity of the silicon nitride film 206 (serving as the upper face of the vibrating film 212) and the silicon nitride film 214 (serving as the lower face of the fixing film 210 through which the openings (the acoustic holes 211) are formed. Besides, the OH group to be substituted by the Si(CH₃)₃ group is less present inherently on the surfaces of the silicon nitride film 206 and the silicon nitride film 214. Accordingly, even if the electret condenser microphone is left in a HMDS atmosphere, the density of the Si(CH₃)₃ group present on the surfaces of the silicon nitride film 206 and the silicon nitride film 214 is small, as shown in FIG. 11B, and therefore, this might results in insufficient water repellency rendered to both the fixing film 210 and the vibrating film 212. Rendering of water repellency by substitution of the OH group by the Si(CH₃)₃ group in a HMDS environment has been known as a technique for improving resist adhesiveness (Patent Document 2).

FIG. 12A and FIG. 12B are illustrations for explaining states of water repellent finishing performed on the inner wall of the air gap in the electret condenser microphone manufacturing method disclosed in Patent Document 2.

As shown in FIG. 10A to FIG. 10F, in manufacture of the joint type electret condenser microphone, less alcohol molecules (CH₃OH, for example), water molecules (H₂O), and the like which inhibit substitution by the Si(CH₃)₃ group, are present in the vicinity of the silicon oxide film 302 adhering to the obverse face of the substrate, as shown in FIG. 12A, because the vibrating film 312 is joined after the recesses serving as the air gaps 309 are formed. On the other hand, the OH group to be substituted by the Si(HC₃)₃ group is present richly on the surface of the silicon oxide film 302. Accordingly, when the electret condenser microphone is left in a HMDS atmosphere, the density of the Si(CH₃)₃ group present on the surface of the silicon oxide film 302 might increase to render sufficient water repellency to the surface of the silicon oxide film 302. As to the vibrating film 312 jointed to the substrate after water repellent finishing, a material excellent in water repellency can be employed, which can solve the above described problems.

In view of the above described acknowledge, the inventor contemplated the following invention as a method for preventing the charge from leaking from the electret to the outside even in the integrally formed electret condenser microphone situated in condensation environment.

Namely, an electret condenser microphone manufacturing method in accordance with a second aspect of the present invention is a method for manufacturing an electret condenser microphone as an integrally formed electret condenser microphone including: a first electrode including an electret and being capable of vibrating; a second electrode opposed to the first electrode with an air gap interposed; and an SiN film covering at least respective parts of the surfaces of the first electrode and the second electrode which are exposed to the air gap, the method including the steps of: (a) performing degasification on the inside of the air gap; (b) forming an SiON film by oxidizing at least the surface of the SiN film after the step (a); and (c) performing silyl group substitution on at least the surface of the SiON film after the step (b).

In the electret condenser microphone manufacturing method in accordance with the second aspect of the present invention, degasification is performed before water repellent finishing, namely, silyl group substitution (silylation) is performed on the inside of the air gap. In other words, water repellent finishing is performed after moisture, alcohol, and the like remaining in the air gap is evaporated and removed by degasification. Further, the surface of the SiN film covering the first electrode and the second electrode is oxidized to form the SiON film before silyl group substitution, enriching the OH group for silyl group substitution. This ensures substitution by the silyl group in the inner wall of the air gap, thereby rendering strong water repellency to respective parts of the surfaces of the first electrode and the second electrode which are exposed to the air gap. Accordingly, even in severe environment liable to cause condensation, the first electrode (the vibrating film) provided with the electret and the second electrode (the fixing film) are prevented from adhesion to each other caused by condensation, thereby preventing the charge stored in the electret from leaking outside to thus improve the reliability of the electret condenser microphone.

In the electret condenser microphone manufacturing method in accordance with the second aspect of the present invention, it is preferable to perform plasma oxidation in the step (b).

With the above arrangement, the SiON film can be formed by definitely oxidizing the surface of the SiN film covering the first electrode and the second electrode even inside the air gap of which openings (acoustic holes and leak holes) communicating with the outside air are small in area. The same effects can be obtained by, for example, baking (thermal oxidation) for a long period of time in an oxygen containing atmosphere in the place of plasma oxidation.

In the electret condenser microphone manufacturing method in accordance with the second aspect of the present invention, it is preferable to perform heating treatment in a HMDS atmosphere in the step (c).

This permits substitution of the OH group (strictly H of the OH group) by the Si(CH₃)₃ group in the air gap in which only the OH group remains by removal of moisture, alcohol, and the like by degasification, thereby rendering strong water repellency to the inner wall of the air gap and the like. Further, HMDS, which is a general silylation reagent easily available at low cost, can attain silyl substitution at low cost.

In the electret condenser microphone manufacturing method in accordance with the second aspect of the present invention, it is preferable to perform at least one of vacuuming and baking in the step (a).

This achieves definite evaporation and removal of moisture, alcohol, and the like remaining in the air gap.

An electret condenser microphone in accordance with the present invention premises an integrally formed electret condenser microphone, which includes: a first electrode including an electret and being capable of vibrating; a second electrode opposed to the first electrode with an air gap interposed; and an SiON film terminating with a silyl group, the SiON film covering at least respective parts of the surfaces of the first electrode and the second electrode which are exposed to the air gap.

Namely, the electret condenser microphone in accordance with the present invention is an electret condenser microphone obtained by the electret condenser microphone manufacturing method in accordance with the second aspect of the present invention, wherein respective parts of the surfaces of the first electrode and the second electrode which are exposed to the air gap are covered with the SiON film terminating with the silyl group. This renders strong water repellency to the first electrode (the vibrating film) provided with the electret and the second electrode (the fixing film). Hence, even in severe environment liable to cause condensation, adhesion of the vibrating film and the fixing film to each other caused by condensation is prevented to prevent the charge stored in the electret from leaking outside, thereby improving the reliability of the electret condenser microphone.

In the electret condenser microphone in accordance with the present invention, preferably, the silyl group is a Si(CH₃)₃ group.

With this arrangement, the electret condenser microphone of the present invention can be manufactured with the use of HMDS, a general silylation reagent easily available at low cost, thereby suppressing the manufacturing cost. The same effects can be obtained with the use of another silylation reagent, such as TMSA (N-Trimetylsilylacetamide), BSA (N,O-Bis(trimethylsilyl)-acetamide), or the like in the place of HMDS.

As described above, the present invention relates to electret condenser microphones and manufacturing methods thereof, can render strong water repellency to the inside of the air gap for preventing the charge stored in the electret from leaking outside even in environment liable to cause condensation, and is, therefore, useful for achieving higher reliability of the electret condenser microphone.

### BRIEF DESCRIPTION OF THE DRAWINGS

FIG. 1A to FIG. 1H are sectional view showing respective steps of an electret condenser microphone manufacturing method in accordance with Embodiment 1 of the present invention.

FIG. 2A and FIG. 2B are graphs showing respective examples of results of temperature programmed desorption analyses before and after degasification in the electret condenser microphone manufacturing method in accordance with Embodiment 1 of the present invention.

FIG. 3A and FIG. 3B are illustrations for explaining a water repellent mechanism obtained by a combination of degasification and water repellent finishing in the electret condenser microphone manufacturing method in accordance with Embodiment 1 of the present invention.

FIG. 4 is an illustration for explaining a water repellent mechanism obtained in a conventional electret condenser microphone manufacturing method as a comparative example.

FIG. 5 is a sectional view of an integrally formed electret condenser microphone in accordance with Embodiment 2 of the present invention.

FIG. 6A to FIG. 6G are sectional views showing respective steps of the integrally formed electret condenser microphone manufacturing method in accordance with Embodiment 2 of the present invention.

FIG. 7A to FIG. 7D are illustrations for explaining states of water repellent finishing performed on the inner wall of an air gap in the integrally formed electret condenser microphone manufacturing method in accordance with Embodiment 2 of the present invention, wherein FIG. 7A shows a state before water repellent finishing; FIG. 7B shows a state after degasification; FIG. 7C shows a state after plasma oxidation; and FIG. 7D shows a state after Si(CH₃)₃ group substitution.

FIG. 8 is a sectional view of an integrally formed electret condenser microphone disclosed in Patent Document 1.

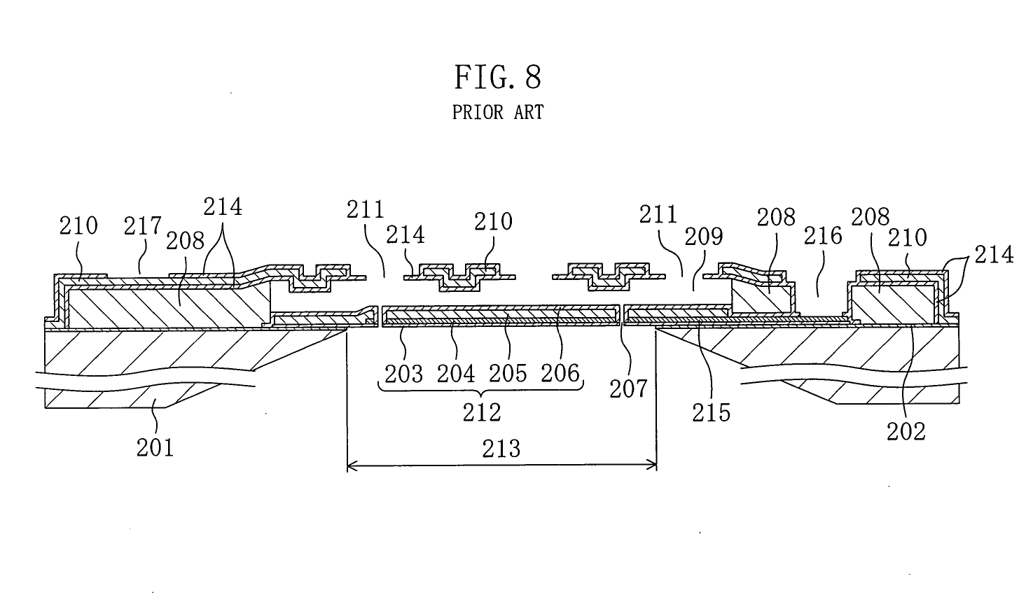

FIG. 9A to FIG. 9F are sectional views showing respective steps of a method of manufacturing an electret condenser microphone having the same basic construction as that of the integrally formed electret condenser microphone disclosed in Patent Document 1.

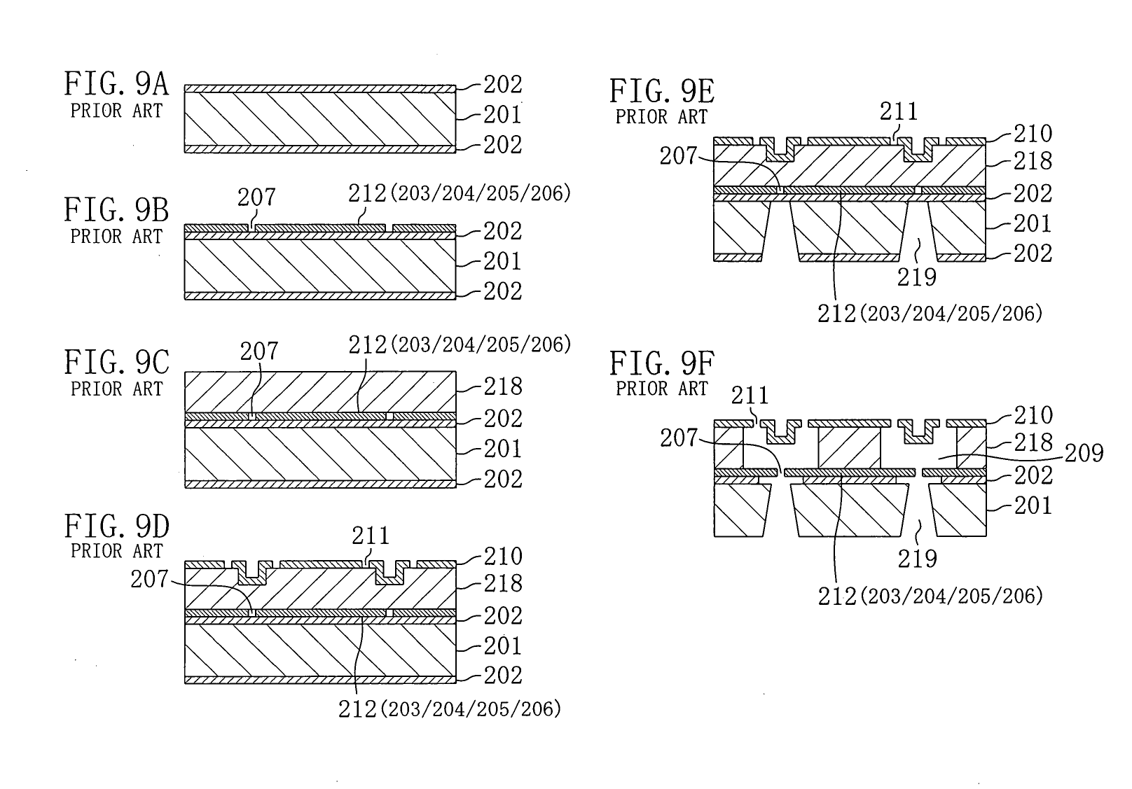

FIG. 10A to FIG. 10F are sectional views showing respective steps of a joint type electret condenser microphone manufacturing method disclosed in Patent Document 2.

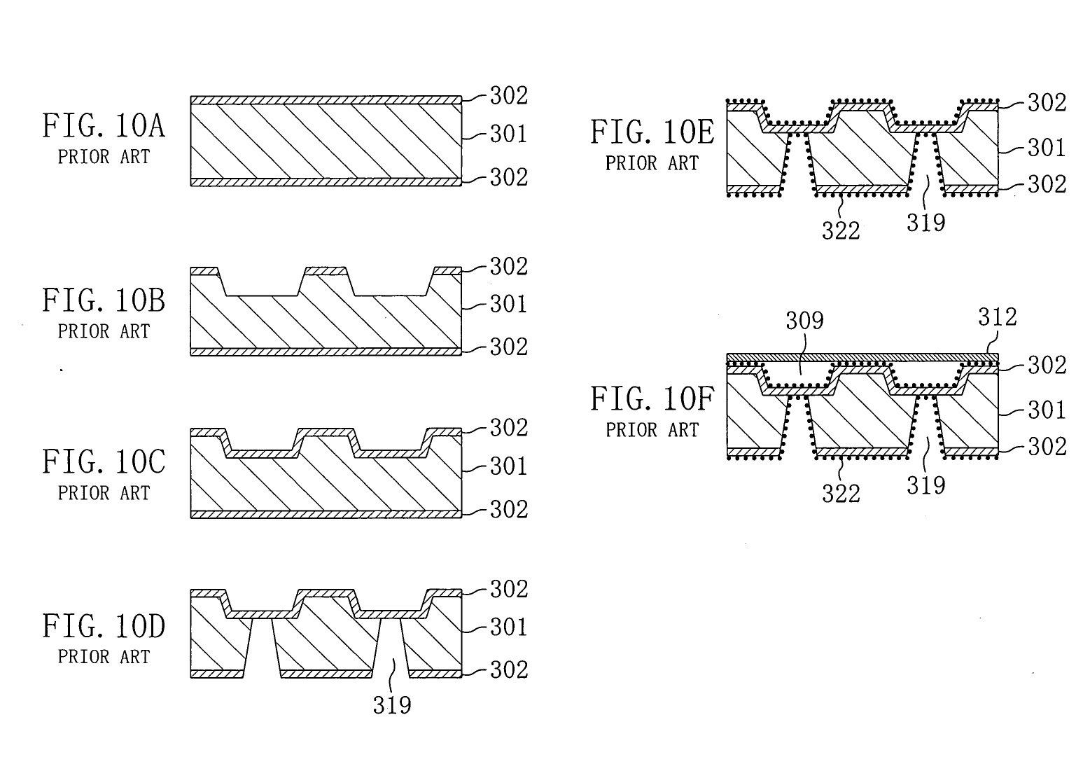

FIG. 11A and FIG. 11B are illustrations for explaining states of water repellent finishing performed on the inner wall of an air gap in the case where water repellent finishing disclosed in Patent Document 2 is applied to the manufacturing method of the integrally formed electret condenser microphone disclosed in Patent Document 1, wherein FIG. 11A shows the initial state, and FIG. 11B shows a state after Si(CH₃)₃ group substitution.

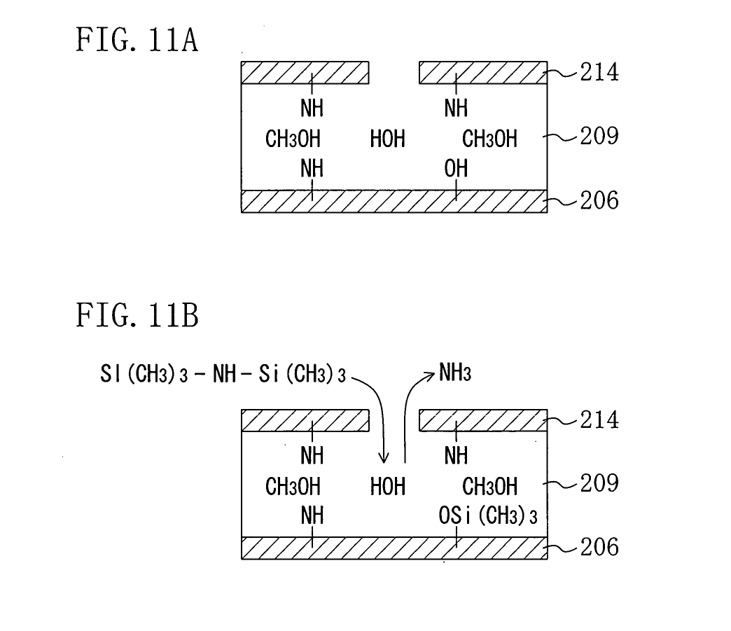

FIG. 12A and FIG. 12B are illustrations for explaining states of water repellent finishing performed on the inner wall of an air gap in the electret condenser microphone manufacturing method disclosed in Patent Document 2, wherein FIG. 12A shows the initial state, and FIG. 12B shows a state after Si(CH₃)₃ group substitution.

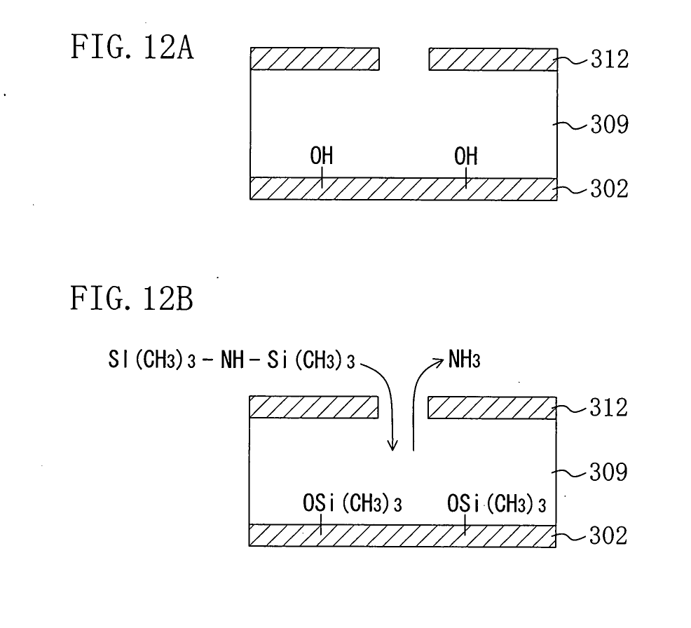

### DESCRIPTION OF PREFERRED EMBODIMENTS

### Embodiment 1

An electret condenser microphone manufacturing method in accordance with Embodiment 1 of the present invention will be described below with reference to the drawings.

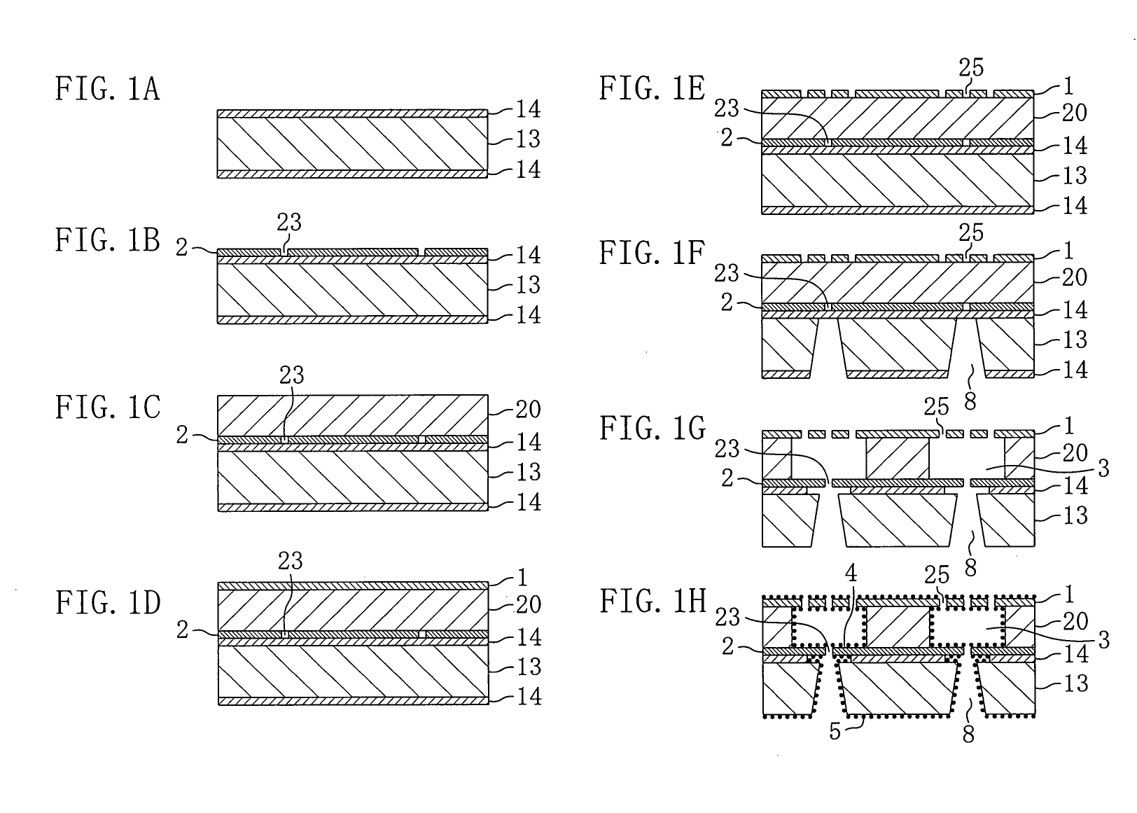

FIG. 1A to FIG. 1H are sectional views showing respective steps of the electret condenser microphone manufacturing method in the present embodiment.

First, as shown in FIG. 1A, an insulating film 14 formed of, for example, a silicon oxide film is formed on each of the obverse face and the reverse face of a semiconductor substrate 13 made of, for example, silicon. Then, as shown in FIG. 1B, a membrane 2, in which, for example, an insulating film to be an electret is layered on a conductive film to be a lower electrode, is formed on the insulating film 14 on the obverse face of the semiconductor substrate 13, and at least one leak hole 23 is formed through the membrane 2.

Subsequently, after a sacrifice layer 20 formed of, for example, a silicon oxide film is formed on the membrane 2, as shown in FIG. 1C, an upper electrode 1 is formed on the sacrifice layer 20, as shown in FIG. 1D. Then, acoustic holes 25 are formed through the upper electrode 1 by a combination of lithography and etching, as shown in FIG. 1E, and at least one through hole 8 is formed by a combination of lithography and etching so as to pass through the semiconductor substrate 13 from the reverse side of the semiconductor substrate 13 to the insulating film 4 on the obverse face of the semiconductor substrate 13, as shown in FIG. 1F.

Thereafter, as shown in FIG. 1G, the sacrifice layer 20 is wet etched partially through the acoustic holes 25 to form at least one air gap 3 between the upper electrode 1 and the membrane 2 (the lower electrode). In this wet etching, the insulating film 14 on the obverse face of the semiconductor substrate 13 is etched partially as well through the leak hole 23.

Finally, as shown in FIG. 1H, water repellent finishing with the use of, for example, HMDS is performed on the semiconductor substrate 13 including the inside of the air gap 3 (a part having water-repellency is denoted by reference numeral 5 (black circles)). Thus, the electret condenser microphone is completed which uses the insulating film serving as a part of the membrane 2 arranged in the air gap 3 as an electret 4.

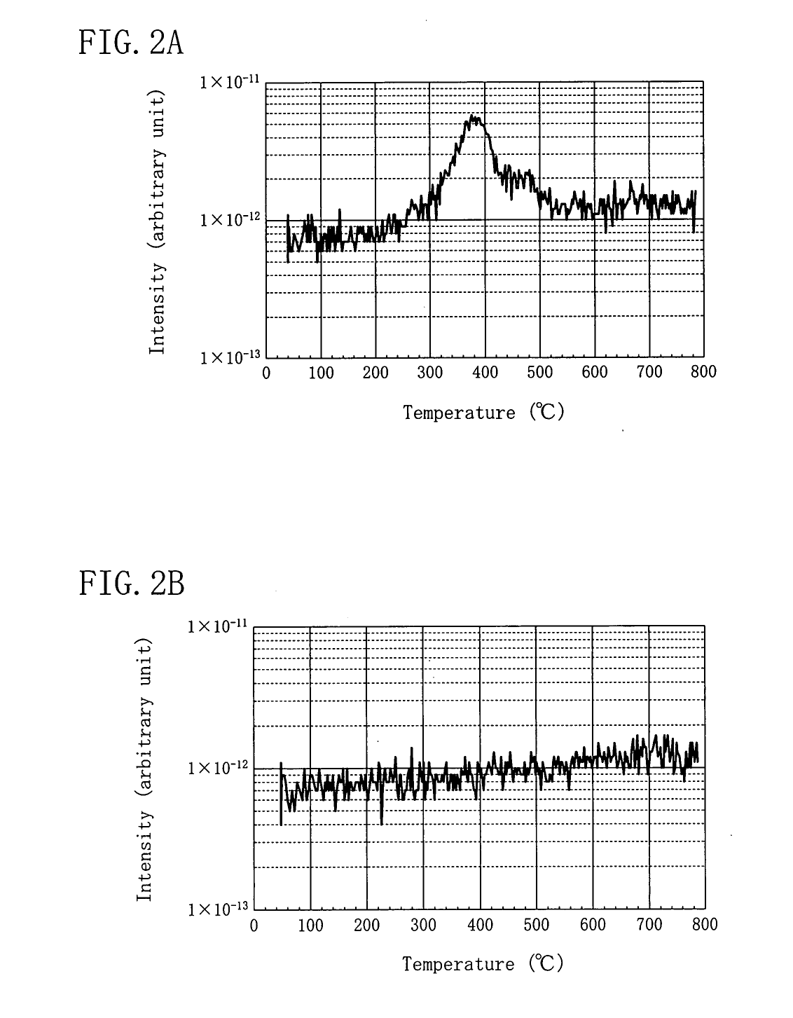

One of significant features of the present embodiment lies in that degasification is performed on the inside of the air gap 3 before water repellent finishing. Degasification is performed by a combination of vacuuming for exposing the semiconductor substrate 13, for example, under a pressure of 25 Pa or lower for one hour or longer and baking for exposing the semiconductor substrate 13, for example, at a temperature of 300° C. or higher for 24 hours or longer. A condition where no peaks of moisture, alcohol, and the like appear in a result of temperature programmed desorption analysis is employed as a condition for degasification. FIG. 2A shows one example of a result of temperature programmed desorption analysis before degasification in the present embodiment, and FIG. 2B shows one example of a result of temperature programmed desorption analysis after degasification in the present embodiment. As can be understood from FIG. 2A and FIG. 2B, the peak appearing before degasification disappears after degasification.

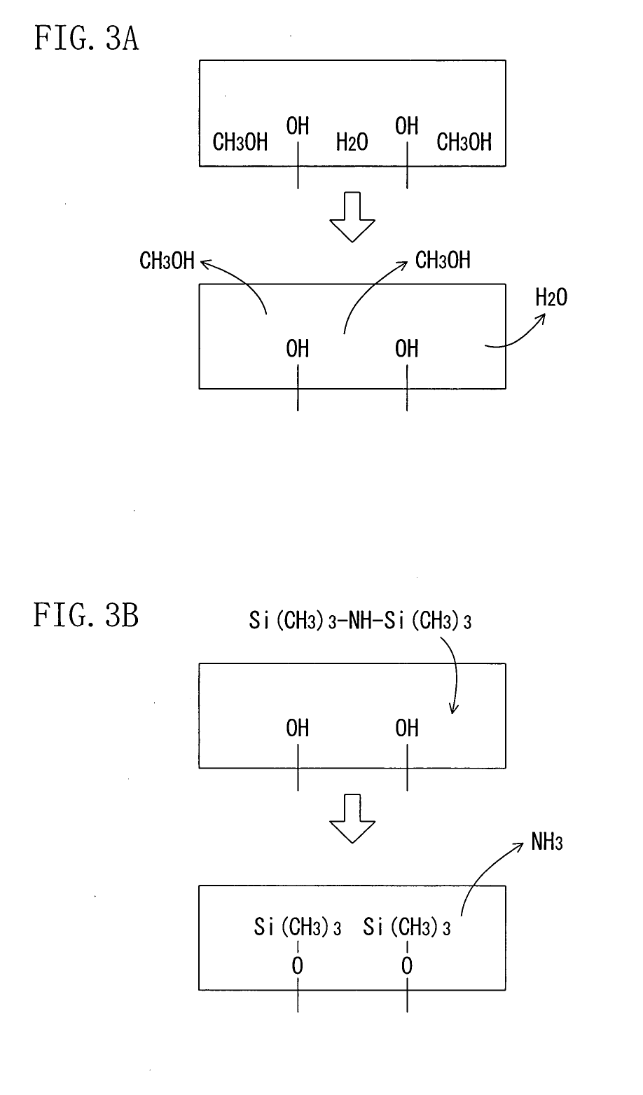

FIG. 3A and FIG. 3B are illustrations for explaining a water repellent mechanism obtained by a combination of degasification and water repellent finishing in the electret condenser microphone manufacturing method of the present embodiment. In FIG. 3A and FIG. 3B, the inner wall of the air gap is drawn into a rectangular shape.

Degasification in the present embodiment evaporates and removes alcohol molecules (for example, CH₃OH), water molecules (H₂O), and the like remaining on the inner wall of the air gap and the like, with a result that only the OH group remains in the air gap, as shown in FIG. 3A.

Subsequently, when water repellent finishing with the use of, for example, HMDS, that is, Si(CH₃)₃—NH—Si(CH₃)₃ is performed, the OH group in the air gap (strictly, H of the OH group) is substituted by the Si(CH₃)₃ group, as shown in FIG. 3B, to render strong water repellency to the inner wall of the air gap and the like.

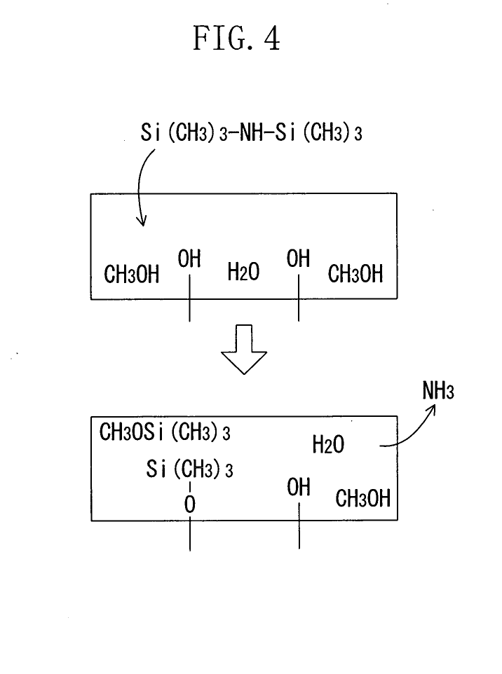

FIG. 4 is an illustration for explaining a water repellent mechanism obtained by a conventional electret condenser microphone manufacturing method as a comparative example, in which only water repellent finishing is performed on the inside of the air gap. In FIG. 4, the inner wall of the air gap is drawn into a rectangular shape, as well.

In the case where only water repellent finishing using HMDS is performed as in the conventional method, water repellent finishing is performed under the state that alcohol molecules (for example, CH₃OH), water molecules (H₂O), and the like remaining on the inner wall of the air gap, so that the OH group (strictly H of the OH group) of the alcohol molecules, the water molecules, and the like are substituted by the Si(CH₃)₃ group. This leads to insufficient substitution of the OH group in the air gap by the Si(CH₃)₃ group, resulting in insufficient water repellent finishing in a micro region of the inner wall of the air gap and the like to invite leakage of the charge from the electret to the outside in condensation environment.

As described above, in the present embodiment, degasification is performed before water repellent finishing with respect to the inside of the air gap. This means that water repellent finishing is performed after moisture, alcohol, and the like remaining in the air gap is evaporated and removed by degasification. Accordingly, water repellent finishing can be performed on the inside of the air gap definitely to render strong water repellency to the inner wall of the air gap and the like. Hence, the charges stored in the electret are prevented from leakage to the outside caused by condensation even in sever environment liable to cause condensation, thereby improving the reliability of the electret condenser microphone.

It is noted that the insulating material of the electret is not limited specifically only if it has an electro-deposition characteristic and may be a silicon oxide film, a silicon nitride film, or the like.

In the present embodiment, HMDS is employed in water repellent finishing, but another silylation reagent, such as TMSA (N-Trimethylsilylacetamide), BSA (N,O-BIs(trimethylsilyl)-acetamide), or the like may be employed in the place thereof.

Furthermore, though both vacuuming and baking are performed as degasification in the present embodiment, only one of evaluation and baking may be performed instead.

In addition, degasification and water repellent finishing may be performed in the same chamber or different chambers in the present embodiment.

### Embodiment 2

An electret condenser microphone and a manufacturing method thereof in accordance with Embodiment 2 of the present invention will be described below with reference to the drawings.

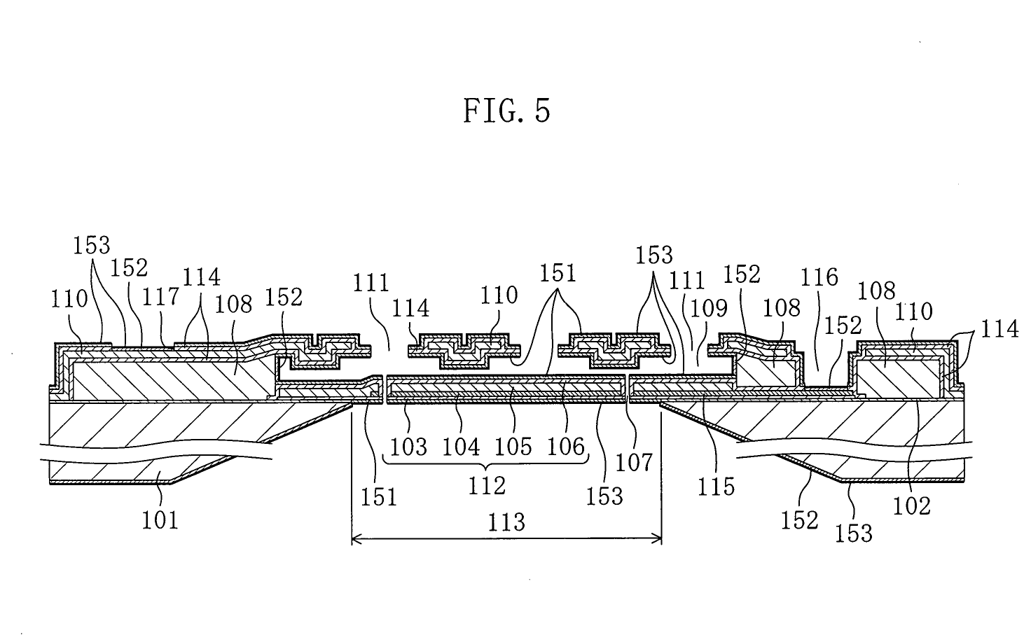

FIG. 5 is a sectional view of an electret condenser microphone, specifically, an integrally formed electret condenser microphone in accordance with the present embodiment.

As shown in FIG. 5, a silicon oxide film 102 is formed on a semiconductor substrate 101, and a membrane region 113 is formed by partially removing the semiconductor substrate 101 and the silicon oxide film 102 with respective predetermined parts (for example, the peripheral parts) thereof left. The membrane region 113 is a region where the semiconductor substrate 101 is removed partially for allowing a vibrating film 112, which will be described later, to vibrate upon receipt of pressure from outside. A silicon nitride film 103 is formed on the silicon oxide film 102 so as to extend across the membrane region 113. One conductive film serving as a lower electrode 104 and an extraction wiring 115 is formed on the silicon nitride film 103. A silicon oxide film 105 and a silicon nitride film 106 are formed sequentially on the silicon oxide film 103, the lower electrode 104, and the extraction wiring 115. At least one leak hole 107 is formed through the silicon nitride film 103, the lower electrode 104, the silicon oxide film 105, and the silicon nitride film 106, and respective parts of the lower electrode 104 and the silicon oxide film 105 which are located within the membrane region 113 are covered with the silicon nitride film 103 or the silicon nitride film 106.

A combination of respective parts of the silicon nitride film 103, the lower electrode 104, the silicon oxide film 105, and the silicon nitride film 106 which are located within the membrane region 113 forms the vibrating film 112. The silicon oxide film 105 is an electret film storing charges. A fixing film (an upper electrode) 110 formed of a conductive film covered with a silicon nitride film 114 is formed above the silicon nitride film 106. An air gap 109 is formed between the vibrating film 112 and the fixing film 110, and a silicon oxide film 108 is formed between the fixing film 110 and respective parts of the silicon nitride film 106 and the silicon oxide film 102 which are located outside the membrane region 113. The air gap 109 ranges over at least the membrane region 113. A plurality of acoustic holes 111 are formed through a part of the fixing film 110 (or the silicon nitride film 114 covering it) which is located above the air gap 109. An opening 116 is formed through the silicon nitride film 114, the fixing film 110, and the silicon oxide film 108 so as to expose a part of the extraction wiring 115. As well, an opening 117 is formed through the silicon nitride film 114 so as to expose a part of the fixing film 110.

One of the significant features of the present embodiment lies in that: a SiON film 151, which includes a surface terminating with a silyl group, such as a Si(CH₃)₃ group or the like (hereinafter referred to it as a silyl group terminating surface 153) is formed on each surface part of the silicon nitride film 103, the silicon nitride film 106, and the silicon nitride film 114 (specifically, respective parts thereof which are exposed to the air gap 109 or the outside air). In other words, respective parts of the surfaces of the lower electrode 104, which is provided with the electret and is capable of vibrating, and the upper electrode as the fixing member 110 which are exposed to the air gap 109 is covered with the SiON film 151 terminating with the silyl group.

A silicon oxide film 152, which has as well a silyl group terminating surface 153, is formed on each of the exposed surface of the semiconductor substrate 101, the exposed surface of the extraction wiring 115 through the opening 116, and the exposed surface of the fixing film 110 through the opening 117. It is noted that the film thickness of the silicon oxide film 152 is smaller than approximately 1 nm, involving no problems in probe inspection, wire bonding, and the like through the openings 116, 117.

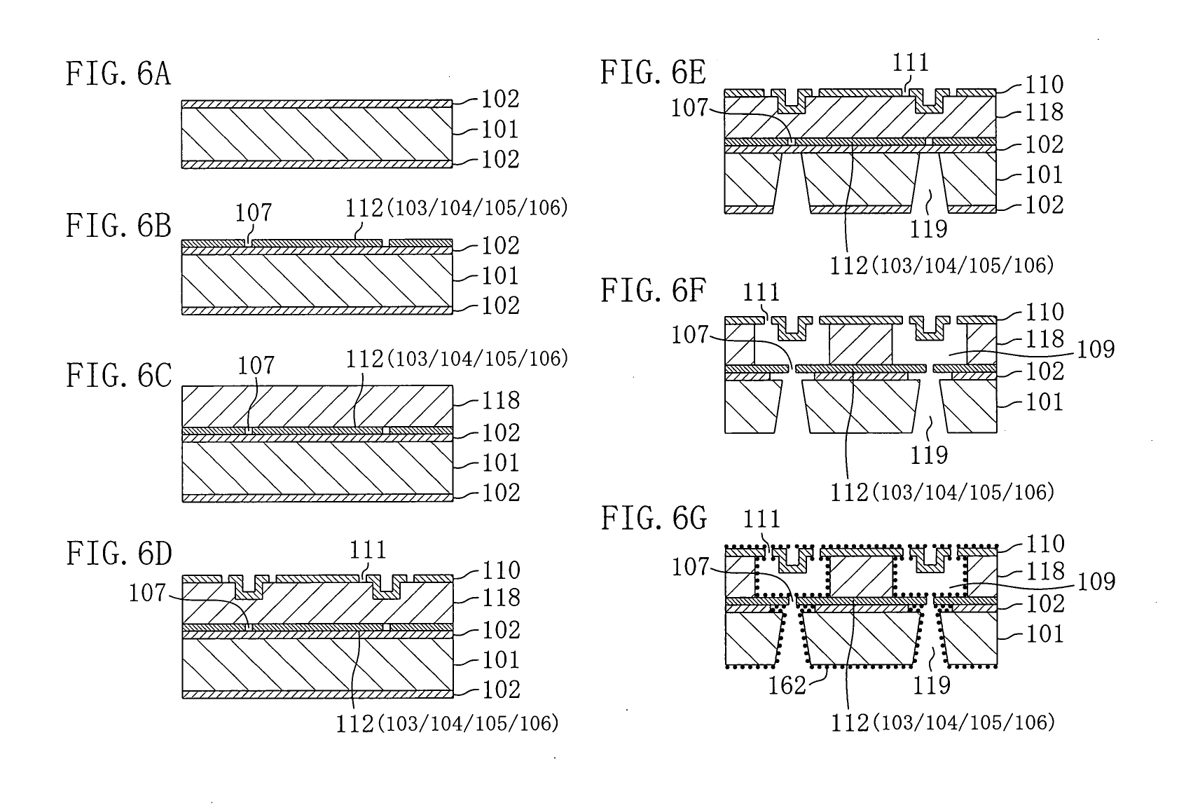

A manufacturing method of the electret condenser microphone in accordance with the present embodiment will be described below with reference to the drawing. FIG. 6A to FIG. 6G are sectional views showing respective steps of the electret condenser microphone manufacturing method, specifically, a manufacturing method of an electret condenser microphone having the same basic construction as that of the integrally formed electret condenser microphone shown in FIG. 5 in the present embodiment. In FIG. 6A to FIG. 6G, the same reference numerals are assigned to the same components as those of the electret condenser microphone shown in FIG. 5 for omitting duplicated explanation and some of the components are not shown for the sake of simple explanation.

First, as shown in FIG. 6A, a silicon oxide film 102, for example, is formed on each of the obverse face and the reverse face of a semiconductor substrate 101 made of, for example, silicon. Then, as shown in FIG. 6B, a silicon nitride film 103, a conductive film to be a lower electrode 104, a silicon oxide film 105, and a silicon nitride film 106 are formed sequentially on the silicon oxide film 102 on the obverse face of the semiconductor substrate 101, and then, the lower electrode 104, at least one leak hole 107, and a vibrating film 107 are formed by a combination of lithography and etching.

Next, as shown in FIG. 6C, a sacrifice layer oxide film 118 where an air gap 109 is formed in the end is deposited.

Subsequently, as shown in FIG. 6D, a fixing film 110 formed of a conductive film covered with a silicon nitride film 114 (not shown in the drawing) and having a concavo-convex structure is formed on the sacrifice layer oxide film 118 by a combination of film deposition, lithography, and etching, and then, acoustic holes 111 are formed through the fixing film 110. Then, as shown in FIG. 6E, at least one through hole 119 is formed by a combination of lithography and etching so as to pass through the semiconductor substrate 101 from the reverse side of the semiconductor substrate 101 to the silicon oxide film 102 on the obverse face of the semiconductor substrate 101.

Thereafter, as shown in FIG. 6F, the sacrifice layer oxide film 118 is wet etched partially through the acoustic holes 111 to form the air gap 109 between the fixing film 110 formed of the conductive film and the vibrating film 112. In this wet etching, the silicon oxide film 102 on the obverse face of the semiconductor substrate 101 is also etched partially through the leak hole 107. Respective parts of the surfaces of the lower electrode 104 and the fixing film 110 to be an upper electrode which are exposed to the air gap 109 are covered with the silicon nitride film 106 or 114.

Thus, the construction of the integrally formed electret condenser microphone is completed in which the vibrating film 112 having the functions of the lower electrode and the electret and the fixing film 110 having the function of the upper electrode are opposed to each other with the air gap 109 interposed.

Finally, as shown in FIG. 6G, water repellent finishing, which will be described later (a part having water-repellency is denoted by reference numeral 162 (black circles)), is performed on the electret condenser microphone including the air gap 109 in the present embodiment, whereby the electret condenser microphone of the present embodiment is completed.

In the present embodiment, water repellent finishing includes three steps of degasification, oxidation (plasma oxidation, for example), and silyl group substitution (Si(CH₃)₃ group substitution). Specifically, after degasification is performed on the inside of the air gap 109, plasma oxidation is performed to form a SiON film 151 on respective surface parts of the silicon nitride film 103, the silicon nitride film 106, and the silicon nitride film 114 (specifically, respective parts thereof which are exposed to the air gap 109 or the outside air). Then, the electret condenser microphone of the present embodiment is left in a HMDS atmosphere to cause substitution of the OH group richly present on the surface of the SiON film 151 by the Si(CH₃)₃ group, thereby forming the SiON film 151 having the silyl group terminated surface 153. The inventor studied the thus formed SiON film 151 with the use of FT-IR (Fourier-transform infrared spectroscopy) to find that no OH group peak appeared. It might be said that 99% or more OH group present on the surface of the SiON film 151 was substituted by the Si(CH₃)₃ group.

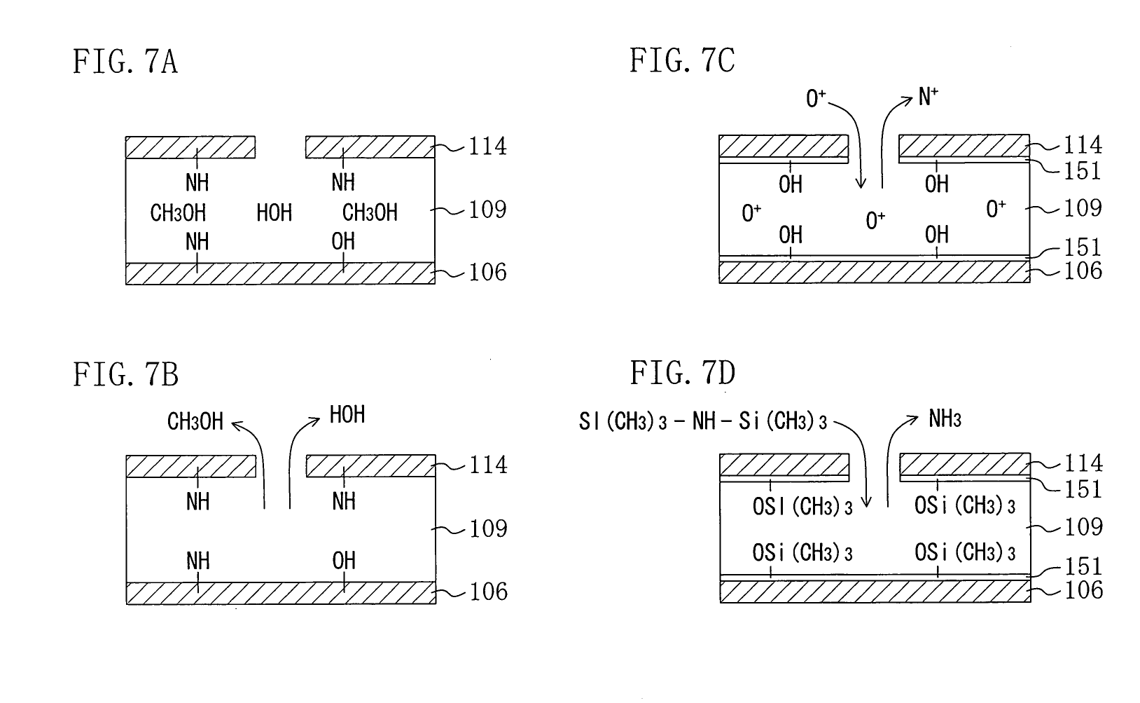

FIG. 7A to FIG. 7D are illustrations for explaining the three steps of the water repellent finishing in the present embodiment. Though the entire surface of the electret condenser microphone including the surfaces of the silicon nitride film 106, the silicon nitride film 114, and the like is subjected to plasma oxidation and Si(CH₃)₃ group substitution in the water repellent finishing in the present embodiment, only parts relevant to water repellent finishing for preventing adhesion of the fixing film and the vibrating film to each other, namely, only the air gap 109 and the silicon nitride films 106, 114 exposed to the air gap 109 are shown in FIG. 7A to FIG. 7D. The other components are not shown and description thereof is omitted. FIG. 7A shows a state before water repellent finishing, FIG. 7B shows a state after degasification, FIG. 7C shows a state after plasma oxidation, and FIG. 7D shows a state after Si(CH₃)₃ group substitution.

As shown in FIG. 7A, before water repellent finishing, alcohol molecules (CH₃OH, for example), water molecules (H₂O), and the like are present in the air gap 109. The alcohol molecules present in the air gap 109 might include organic solvents, such as acetone, isopropylene, and the like besides CH₃OH. Further, less OH group is present but a NH group is present richly on the surfaces of the silicon nitride films 106, 114 exposed to the air gap 109.

First, degasification as the first step of water repellent finishing is performed as a combination of vacuuming for exposing the electret condenser microphone, for example, under a pressure of 25 Pa or lower for one hour or longer and baking for exposing the electret condenser microphone, for example, at a temperature of 300° C. or higher for 24 hours or longer. A condition where no peaks of moisture, alcohol, and the like appear in a result of temperature programmed desorption analysis is employed as a condition for degasification. Degasification in the present embodiment evaporates and removes the alcohol molecules (CH₃OH, for example), the water molecules (H₂O), and the like remaining on the inner wall of the air gap 109 and the like, as shown in FIG. 7B.

Next, plasma oxidation as the second step of water repellent finishing is performed by leaving the electret condenser microphone, for example, for approximately six hours in plasma generated by supplying an RF voltage of 500 W to a gaseous mixture of, for example, an oxygen gas and a nitrogen gas. This causes oxygen plasma, which reaches the silicon nitride film 106 or 114 composing the inner wall of the air gap 109 through the openings (the acoustic holes 111) of the silicon nitride film 114, to plasma oxidize the surfaces of the silicon nitride film 106 and the silicon nitride film 114, thereby forming the SiON film 151 on the surfaces of the silicon nitride film 106 and the silicon nitride film 114. On the surface of the SiON film 151 exposed to the air gap 109, the OH group is present richly.

Finally, Si(CH₃)₃ group substitution as the third step of water repellent finishing is performed by leaving the electret condenser microphone, for example, in a HMDS atmosphere, that is, a Si(CH₃)₃—NH—Si(CH₃)₃ atmosphere. This causes the OH group on the surface of the SiON film 151 to be substituted by the Si(CH₃)₃ group, as shown in FIG. 7D, to thus form, on the inner wall of the air gap 109, the SiON film 151 covered with the Si(CH₃)₃ group having strong water repellency, namely, having the silyl group terminated surface 153.

In the present embodiment, HMDS is employed as the material for causing. silylation as Si(CH₃)₃ group substitution, but another silylation reagent, such as TMSA, BSA, or the like may be employed.

The effects of water repellent finishing in the present embodiment can be confirmed by a contact angle test, for example. Specifically: when conventional water repellent finishing disclosed in Patent Document 2 was preformed on the electret condenser microphone disclosed in Patent Document 1, the contact angle of the surface of the vibrating film exposed to the air gap was approximately 70 degrees; while water repellent finishing in the present embodiment attained a contact angle of 80 degrees or larger at the surface of the vibrating film exposed to the air gap.

As described above, in the present embodiment, degasification is performed before performing water repellent finishing, that is, silyl group substitution on the inside of the air gap 109. This means that water repellent finishing is performed after moisture, alcohol, and the like remaining in the air gap 109 are evaporated and removed by degasification. Further, the surfaces of the silicon nitride films 106, 114 respectively covering the lower electrode 104 and the upper electrode (the fixing film 110) are oxidized to form the SiON film 151 before silyl group substitution, so that the OH group to be substituted by the silyl group becomes rich thereon. This secures silyl group substitution on the inner wall of the air gap 109 to thus form the SiON film 151 covered with the Si(CH₃)₃ group having strong water repellency, namely, the silyl group terminated surface 153 at respective parts of the surfaces of the lower electrode 104 and the upper electrode (the fixing film 110) which are exposed to the air gap 109. Hence, the vibrating film 112, i.e., the lower electrode 104 having an electret and the fixing film 110 are prevented from adhesion to each other caused by condensation even in severe environment liable to cause condensation to prevent the charges stored in the electret from leaking outside, thereby improving the reliability of the integrally formed electret condenser microphone.

Furthermore, in the present embodiment, plasma oxidation is employed for forming the SiON film 151 by oxidizing the surfaces of the silicon nitride films 106, 114 respectively covering the lower electrode 104 and the upper electrode (the fixing film 110). This enables definite oxidation of the surfaces of the silicon nitride films 106, 114, thereby forming the SiON film 151 even in the air gap 109 of which openings (the acoustic holes 111 and the leak hole 107) communicating with the outside air are small in area.

In the present embodiment, the insulating material for the electret is not limited specifically only if it has an electro-deposition characteristic and may be a silicon oxide film, a silicon nitride film, or the like.

Moreover, both vacuuming and baking are performed as degasification in the present embodiment, but only one of vacuuming and baking may be performed.

In addition, in the present embodiment, though plasma oxidation is employed for forming the SiON film 151 by oxidizing the surfaces of the silicon nitride films 106, 114 respectively covering the lower electrode 104 and the upper electrode (the fixing film 110), baking (thermal oxidation) may be performed for a long period of time, for example, in an oxygen containing atmosphere in the place thereof.

What is claimed is:

1. A method for manufacturing an electret condenser microphone which includes a first electrode provided with an electret and a second electrode opposed to the first electrode with an air gap interposed, the method comprising the steps of:
(a) performing degasification on the inside of the air gap; and
(b) performing water repellent finishing on at least the inside of the air gap after the step (a).

2. The method of claim 1,
wherein heating treatment in a HMDS atmosphere is performed in the step (b).

3. The method of claim 1,
wherein at least one of vacuuming and baking is performed the step (a).

4. An electret condenser microphone as an integrally formed electret condenser microphone, comprising:
a first electrode provided with an electret and being capable of vibrating;
a second electrode opposed to the first electrode with an air gap interposed; and
an SiON film terminating with a silyl group, the SiON film covering at least respective parts of the surfaces of the first electrode and the second electrode which are exposed to the air gap.

5. The electret condenser microphone of claim 4,
wherein the silyl group is a Si(CH₃)₃ group.

6. A method for manufacturing an electret condenser microphone as an integrally formed electret condenser microphone including: a first electrode provided with an electret and being capable of vibrating; a second electrode opposed to the first electrode with an air gap interposed; and an SiN film covering at least respective parts of the surfaces of the first electrode and the second electrode which are exposed to the air gap, the method comprising the steps of:
(a) performing degasification on the inside of the air gap;
(b) forming an SiON film by oxidizing at least the surface of the SiN film after the step (a); and
(c) performing silyl group substitution on at least the surface of the SiON film after the step (b).

7. The method of claim 6,
wherein plasma oxidation is performed in the step (b).

8. The method of claim 6,
wherein heating treatment in a HMDS atmosphere is performed in the step (c).

9. The method of claim 6,
wherein at least one of vacuuming and baking is performed in the step (a).
